(19) United States
(12) Patent Application Publication
(10) Pub. No.: US 2020/0027129 A1
(43) Pub. Date: Jan. 23, 2020

(54) INFORMATION PROCESSING APPARATUS AND INFORMATION PROCESSING METHOD

(71) Applicant: TOYOTA JIDOSHA KABUSHIKI KAISHA, Toyota-shi (JP)

(72) Inventors: Yusuke KANEKO, Toyota-shi (JP); Junya MASUI, Nagoya-shi (JP); Yui NAKAMURA, Nagoya-shi (JP); Ai FUJIMURA, Nisshin-shi (JP); Keisuke TSUJIMOTO, Toyota-shi (JP); Tomoyuki KURIYAMA, Hadano-shi (JP)

(73) Assignee: TOYOTA JIDOSHA KABUSHIKI KAISHA, Toyota-shi (JP)

(21) Appl. No.: 16/512,984

(22) Filed: Jul. 16, 2019

(30) Foreign Application Priority Data
Jul. 18, 2018 (JP) 2018-135017

(51) Int. Cl. G06Q 30/02; G06F 16/9537

(52) U.S. Cl. CPC G06Q 30/0266; G06Q 30/0267; G06F 16/9537

(57) ABSTRACT

An information processing apparatus comprises a controller which executes: acquiring information relating to a destination of a user of a vehicle; extracting advertisement information of a facility which is located within a first range including the destination and for which advertisement information is to be provided to the user; acquiring a current location of a terminal of the user; judging whether or not the current location of the terminal of the user is located within a second range including the destination; and transmitting the advertisement information to the terminal of the user in a case where the current location of the terminal of the user is located within the second range.

### CROSS REFERENCE TO THE RELATED APPLICATION

This application claims the benefit of Japanese Patent Application No. 2018-135017, filed on Jul. 18, 2018, which is hereby incorporated by reference herein in its entirety.

### BACKGROUND

### Technical Field

The present disclosure relates to an information processing apparatus and an information processing method.

### Description of the Related Art

For the purpose of relieving traffic congestion, saving fuel cost, taking environmental measures, and the like, a form in which a plurality of users share a ride on one vehicle and move (ride-sharing) is widely used mainly in foreign countries. Further, in such a moving form, a technique for matching a plurality of users has been developed.

As a technique relating to this, Patent literature 1 discloses a system in which data relating to interaction performed by a plurality of users who share a ride and move on a vehicle is acquired, and information is further provided on the basis of the interaction.

### CITATION LIST

### Patent Literature

[Patent Literature 1] US Patent Publication No. 2017/0351990

### SUMMARY

The present disclosure is directed to providing advertisement information to a user of a vehicle more effectively.

The present disclosure in its one aspect provides an information processing apparatus comprising a controller which executes: acquiring information relating to a destination of a user of a vehicle; extracting advertisement information of a facility which is located within a first range including the destination and for which advertisement information is to be provided to the user; acquiring a current location of a terminal of the user; judging whether or not the current location of the terminal of the user is located within a second range including the destination; and transmitting the advertisement information to the terminal of the user in a case where the current location of the terminal of the user is located within the second range.

The present disclosure in its another aspect provides an information processing method comprising: a step of acquiring information relating to a destination of a user of a vehicle; a step of extracting advertisement information of a facility which is located within a first range including the destination and for which advertisement information is to be provided to the user; a step of acquiring a current location of a terminal of the user; a step of judging whether or not the current location of the terminal of the user is located within a second range, including the destination; and a step of transmitting the advertisement information to the terminal of the user in a case where the current location of the terminal of the user is located within the second range.

The present disclosure in its another aspect provides a non-transitory computer readable storing medium recording a computer program for causing a computer to perform an information processing method comprising; a step of acquiring information relating to a destination of a user of a vehicle; a step of extracting advertisement information of a facility which is located within a first range including the destination and for which advertisement information is to be provided to the user; a step of acquiring a current location of a terminal of the user; a step of judging whether or not the current location of the terminal of the user is located within a second range including the destination; and a step of transmitting the advertisement information to the terminal of the user in a case where the current location of the terminal of the user is located within the second range.

According to the present disclosure, it is possible to provide advertisement information to a user of a vehicle more effectively.

### BRIEF DESCRIPTION OF THE DRAWINGS

FIG. 1 is a schematic configuration diagram of an advertisement delivery system according to a first embodiment;

FIG. 2 is a system configuration diagram of an advertisement delivery server 20 according to the first embodiment;

FIG. 3 is a diagram illustrating an example of a ride sharing management information according to the first embodiment;

FIG. 4 is a diagram illustrating an example of advertisement management information according to the first embodiment;

FIG. 5 is a system configuration diagram of a user terminal according to the first embodiment;

FIG. 6 is a flowchart of facility extraction processing;

FIG. 7 is a diagram explaining an example of processing of the advertisement delivery server according to the first embodiment;

FIG. 8 is a diagram illustrating an example of target facility information according to the first embodiment;

FIG. 9 is a flowchart of advertisement delivery processing according to the first embodiment;

FIG. 10 is a system configuration diagram of an advertisement delivery server according to a second embodiment;

FIG. 11 is a diagram illustrating an example of ride sharing management information according to the second embodiment;

FIG. 12 is a diagram illustrating an example of advertisement management information according to the second embodiment;

FIG. 13 is a diagram illustrating an example of related facility information according to the second embodiment;

FIG. 14A is a flowchart of related facility extraction processing;

FIG. 14B is a flowchart of the related facility extraction processing;

FIG. 15 is a diagram explaining an example of processing of the advertisement delivery server according to the second embodiment;

FIG. 16 is a diagram illustrating an example of target related facility information according to the second embodiment;

FIG. 17 is a flowchart of advertisement delivery processing according to the second embodiment;

FIG. 18 is a diagram illustrating an example of ride sharing management information according to a third embodiment;

FIG. 19 is a diagram illustrating an example of ride sharing management information according to a fourth embodiment;

FIG. 20 is a diagram illustrating an example of target facility information according to the fourth embodiment; and

FIG. 21 is a diagram illustrating an example of ride sharing management information according to a fifth embodiment.

### DESCRIPTION OF THE EMBODIMENTS

An information processing apparatus according to a first aspect of the present disclosure acquires information relating to a destination of a user of a vehicle, and extracts a facility which is located within a first, range including the destination and for which advertisement information is to be provided to the user. Then, the information processing apparatus acquires a current location of a terminal of the user, and, in the case where the current location is located within a second range including the destination, transmits the advertisement information to the terminal of the user.

In the case where advertisement information is provided to the user of the vehicle, by providing advertisement information useful for the user using a method which makes an impression, it is possible to provide advertisement information to the user more effectively.

Therefore, in an information processing apparatus according to a first embodiment of the present disclosure, advertisement information for a facility which exists within a search range which is within a first range including a destination of a user is provided. In this manner, because a facility located around the destination of the user can be easily utilized by the user who gets off a vehicle, an effect of encouraging the user to utilize the facility is high. Further, in the information processing apparatus according to the first embodiment of the present disclosure, in the case where a current location of a terminal of the user is located within a delivery range which is within a second range including the destination, the advertisement information for the facility as described above is transmitted to the terminal of the user. In this manner, by providing the advertisement information at a timing at which the user approaches the destination, it is possible to provide the advertisement information of the facility located around the destination in a form which makes an impression on the user.

Here, the destination of the user does not necessarily have to be a location where the user gets off a vehicle, because there is also a case where a location somewhat away from the destination is set as the location where the user gets off a vehicle in terms of protection of privacy.

While the first range and the second range can be specified by a distance from the destination, administrative geographical ranges such as within a town and within a city can be set as the first range and the second range. Further, the first range and the second range can be also specified by travel time to the destination. For example, the first range and the second range can be specified such that the first, range can be specified as some minutes on foot, or the like, and the second range can be specified as some minutes by car, or the like.

Further, the number of users is not limited. There may be one user or a plurality of users.

In the case where there are a plurality of users, basically, facilities for which advertisement information is to be provided are extracted in relation to destinations of the respective users. Therefore, while the users receive different advertisement information through respective terminals, it is also possible to make a setting so that the plurality of users receive common advertisement information.

Further, a user terminal as the terminal of the user may be an in-vehicle terminal which is mounted on a vehicle and which designates a traveling route of the vehicle. Further, the information processing apparatus may be such an in-vehicle terminal. The vehicle may be a vehicle which is manually driven by a driver or may be a vehicle which autonomously travels. The in-vehicle terminal may be a navigation apparatus or an apparatus connected to the navigation apparatus, or may be a computer for performing autonomous traveling.

Functions of the information processing apparatus may be shared among computer apparatuses connected to the in-vehicle terminal via a network, and advertisement information may be transmitted to the terminal of the user from the in-vehicle terminal via a network such as a wireless LAN.

Specific embodiments of the present disclosure will be described below on the basis of the drawings. Hardware configurations, module configurations, functional configurations, or the like, described in the respective embodiments are not intended to limit a technical scope of the disclosure merely to these configurations unless otherwise described.

### First Embodiment

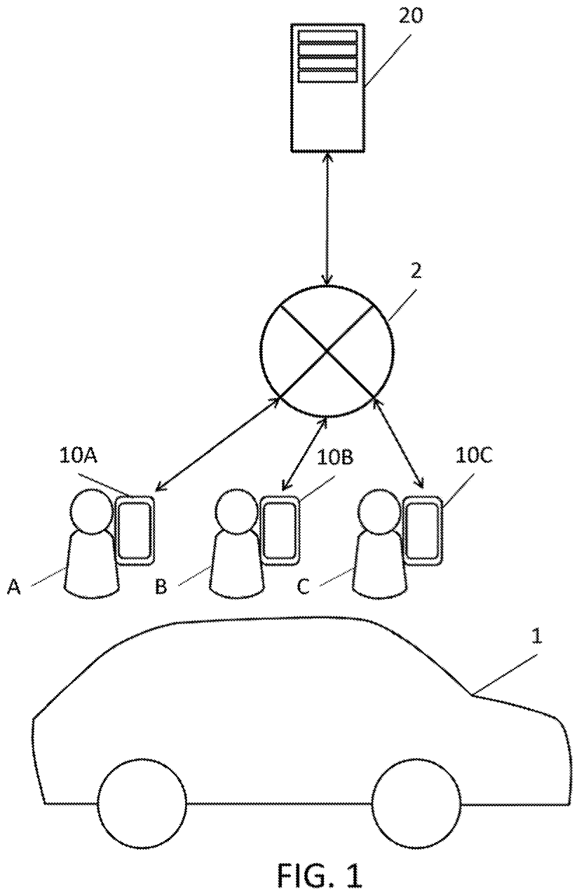

A schematic configuration diagram of an advertisement delivery system according to a first embodiment is illustrated in FIG. 1. The advertisement delivery system according to the present embodiment includes user terminals 10A, 10B and 10C carried by users who share a ride on a vehicle 1 which is to be used for ride sharing, and an advertisement delivery server 20.

The advertisement delivery server 20 transmits advertisement information of facilities extracted on the basis of destinations of the users A, B and C to the user terminals 10A, 10B and 10C via a network 2 in accordance with predetermined conditions relating to current locations of the user terminals 10A, 10B and 10C. The user terminals 10A, 10B and 10C transmit the current locations of the user terminals 10A, 10B and 10C to the advertisement delivery server 20 via the network 2, and receive advertisement information from the advertisement delivery server 20 in accordance with the predetermined conditions relating to the current locations. While A, B and C are displayed in FIG. 1 as users, the number of users is not limited.

In the advertisement, delivery system according to the present embodiment, the user terminals 10A, 10B and 10C (hereinafter, A, B and C will be omitted except a case where a specific user or user terminal is referred to) and the advertisement delivery server 20 are connected to each other using the network 2. For example, a WAN (Wide Area Network) which is a global public telecommunication network such as the Internet and other communication networks may be employed as the network 2. Further, the network 2 may include a telecommunication network such as a mobile phone, and a wireless communication network such as Wi-Fi (registered trademark).

A configuration of the advertisement delivery server 20 will be described.

The advertisement delivery server 20 is constituted with a typical computer. That is, the advertisement delivery server 20 is a computer including a processor such as a CPU and a GPU, a main memory such as a RAM and a ROM and an auxiliary memory such as an EPROM, a hard disk drive and a removable medium. Note that the removable medium may be, for example, a USB memory or a disk recording medium such as a CD and a DVD. In the auxiliary memory, an operating system (OS), various kinds of programs, various kinds of tables, or the like, are stored, and by the programs stored therein being loaded to a work area of the main memory and executed, and respective components, or the like, being controlled through execution of the programs, respective functions which suit predetermined purpose and which will be described later can be implemented. However, part or all functions may be implemented by a hardware circuit such as an ASIC and an FPGA. Note that the advertisement delivery server 20 may be constituted with a single computer or may be constituted with a plurality of computers which coordinate with each other.

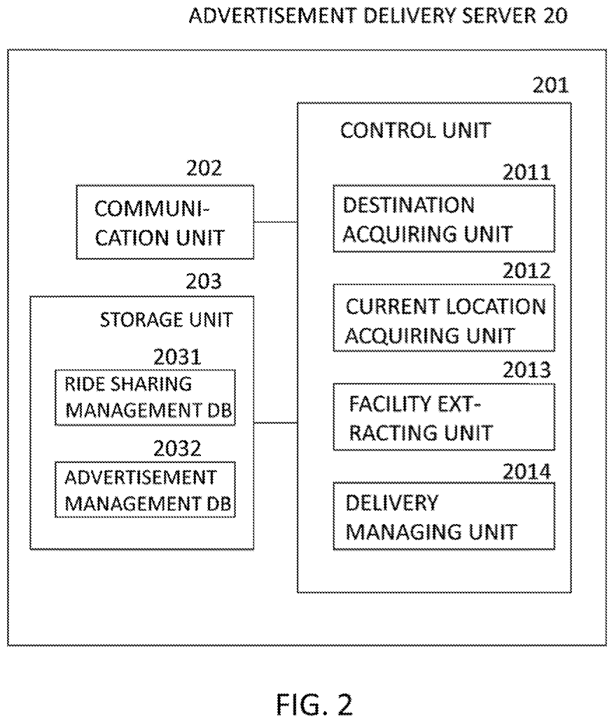

FIG. 2 is a diagram illustrating a system configuration of the advertisement delivery server 20. The advertisement delivery server 20 includes a communication unit 202, a storage unit 203 and a control unit 201.

The communication unit 202 is a communication interface for connecting the advertisement delivery server 20 to the network 2. The communication unit 202 includes, for example, a network interface board and a wireless communication circuit for wireless communication.

The storage unit 203 includes a main memory and an auxiliary memory. The main memory is a memory in which programs to be executed by the control unit 201 and data to be utilized by the control programs are expanded. The auxiliary memory is a device in which the programs to be executed at the control unit 201 and data to be utilized by the control programs are stored. By the programs stored in the auxiliary memory being loaded to the main memory and executed at the control unit 201, processing which will be described below is performed.

The main memory may include a RAM (Random Access Memory) and a ROM (Read Only Memory). Further, the auxiliary memory may include an EPROM (Erasable Programmable ROM) and a hard disk drive (HDD). Still further, the auxiliary memory may include a removable medium, that is, a portable recording medium. The removable medium is, for example, a USB (Universal Serial Bus) memory or a disk recording medium such as a CD (Compact Disc) and a DVD (Digital Versatile Disc).

Further, the storage unit 203 stores a ride sharing management database 2031 and an advertisement management database 2032.

The ride sharing management database 2031 is a database in which information regarding ride sharing of the user A, or the like, acquired from the user terminal 10A, or the like, is stored. Information regarding all the users A, B and C who share a ride on the vehicle 1 is stored.

The advertisement management database 2032 is a database in which information relating to advertisement information to be delivered to the user terminal 10 is stored.

The ride sharing management database 2031 and the advertisement management database 2032 are constructed by a program of a database management system (DBMS) to be executed by the processor managing data stored in the memory. The ride sharing management database 2031 and the advertisement management database 2032 are, for example, relational databases.

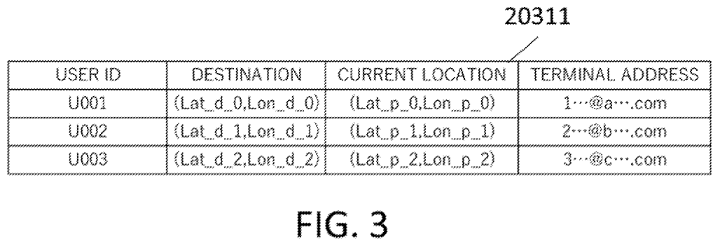

Here, a table configuration of the ride sharing management information 20311 of the users A, B and C stored in the ride sharing management database 2031 will be described with reference to FIG. 3. FIG. 3 is a diagram illustrating an example of the table configuration of the ride sharing management information 20311 of the users stored in the ride sharing management database 2031. The ride sharing management information table 20311 has a user ID field, a destination field, a current, location field and a terminal address field.

In the user ID field, user IDs which are identification information for specifying users are stored. In FIG. 3, U001, U002 and U003 are respectively stored as user IDs of the user A, the user B and the user C.

In the destination field, information regarding destinations of the user A, or the like, in ride sharing is stored. The destinations are expressed with latitude and longitude. In FIG. 3, (Lat_d_0, Lon_d_0) is stored as the destination of the user A.

In the current location field, current locations of the user terminals 10 are stored. The current locations of the user terminals 10 are expressed with latitude and longitude. In FIG. 3, (Lat_p_0, Lon_p_0) is stored as the current location of the user terminal 10A of the user A.

In the terminal address field, addresses of the user terminals 10 which are transmission destinations of advertisement information are stored. In FIG. 3, 1. . .@a. . . .com is stored as an address of the user terminal of the user U001. While transmission destinations are specified by e-mail addresses of the user terminals 10 here, the transmission destinations can be specified by appropriate information which can specify the user terminals 10 in accordance with a communication scheme when advertisement information is transmitted.

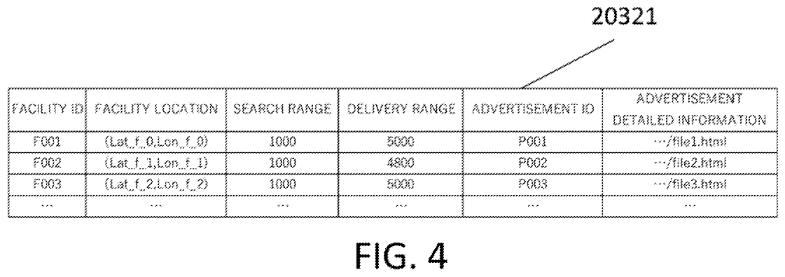

A table configuration of the advertisement management information 20321 stored in the advertisement management database 2032 will be described next with, reference to FIG. 4. FIG. 4 is a diagram illustrating an example of the table configuration of the advertisement management information 20321 stored in the advertisement management database 2032. The advertisement management information table 20321 has a facility ID field, a facility location field, a search range field, a delivery range field, an advertisement ID field and an advertisement detailed information field.

In the facility ID field, facility IDs which are identification information for specifying facilities for which advertisement information is to be delivered on the basis of the destinations of the users A, B and C are stored. The facilities include stores, commercial facilities including a plurality of stores, business facilities such as business offices and factories, leisure facilities such as parks and amusement parks, public facilities such as government offices of local governments, sightseeing facilities, and event venues such as concert halls and theaters, and may be facilities for which advertisement information is to be delivered. In FIG. 4, F001, F002, F002, or the like, are stored as the facility IDs.

In the facility location field, information specifying locations of the facilities is stored. Here, the locations of the facilities ace expressed with latitude and longitude. In FIG. 4, (Lat_f_0, Lon_f_0) is stored as a location of a facility (hereinafter, also referred to as a facility F001) whose facility ID is F001.

In the search range field, information specifying ranges in which facilities for which advertisement information is to be delivered are searched for in relation to the destinations of the users A, B and C is stored. Here, the ranges to be searched are expressed by distances from the destinations of the users A, B and C. In FIG. 4, 1000 (a unit of data relating to a distance is meter) is stored in the search range field of the facility F001.

In the delivery range field, information specifying ranges in which advertisement information is to be delivered to users in relation to the current locations of the users A, B and C is stored. Here, ranges in which advertisement information is to be delivered is expressed by distances from the destinations of the users A, B and C. In FIG. 4, 5000 is stored in the delivery range field of the facility F001.

In the advertisement ID field, advertisement IDs which are identification information for specifying advertisement information are stored. In FIG. 4, P001 is stored as the advertisement ID of the facility of F001.

In the advertisement detailed information field, detailed information of an advertisement to be delivered is stored. Here, the detailed information of the advertisement is expressed with path name of a file of the advertisement information. In FIG. 4, . . ./file1.html is stored as the advertisement detailed information of the facility of F001.

The control unit 201 is an arithmetic device which manages control to be performed by the advertisement delivery server 20. The control unit 201 can be implemented by an arithmetic processing unit such as a CPU.

The control unit includes functional modules of a destination acquiring unit 2011, a current location acquiring unit 2012, a facility extracting unit 2013 and a delivery managing unit 2014. The respective functional modules may be implemented by programs stored in auxiliary storage means being executed by the CPU.

The destination acquiring unit 2011 acquires information relating to a destination from the user terminal 10, stores the information in the ride sharing management database 2031 and updates the information in the ride sharing management database 2031 as needed.

The current location acquiring unit 2012 acquires the current location of the user terminal 10 from the user terminal 10 and updates the current location in the ride sharing management database 2031.

The facility extracting unit 2013 extracts facilities for which distances between locations of the facilities and the destinations of the users A, B and C fall within the search ranges.

The delivery managing unit 2014 judges whether or not distances between the current locations of the user terminals 10A, 10B and 10C and the destinations of the users A, B and C fail within the delivery ranges, and, in the case where the distances fall within the delivery ranges, transmits advertisement information to the user terminals 10A, 10B and 10C via the network 2.

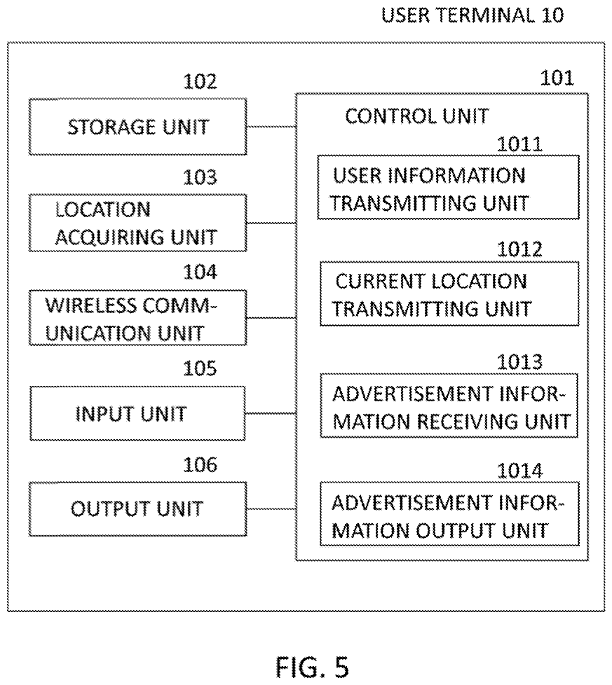

A configuration of the user terminal 10 will be described next. FIG. 5 is a diagram illustrating a system configuration of the user terminal.

The user terminal 10 is, for example, a small computer such as a smartphone, a mobile phone, a tablet computer, a personal digital assistant, a notebook computer and a wearable computer (such as a smart watch). The user terminal 10 includes a control unit 101, a storage unit 102, a location acquiring unit 103, a wireless communication unit 104, an input unit 105 and an output unit 106.

The control unit 101 is an arithmetic device which manages control to be performed by the user terminal 10. The control unit 101 can be implemented with an arithmetic processing unit such as a CPU (Central Processing Unit).

The control unit 101 includes functional modules of a user information transmitting unit 1011, a current location transmitting unit 1012, an advertisement information receiving unit 1013 and an advertisement information output unit 1014. The respective functional modules may be implemented by programs stored in the storage unit 102 which will be described later being executed by the CPU.

The user information transmitting unit 1011 transmits information relating to a destination acquired from the user A, or the like, through the input unit 105, to the advertisement delivery server 20.

The current location transmitting unit 1012 transmits the current location of the user terminal 10 acquired by the location acquiring unit 103, to the advertisement delivery server 20.

The advertisement information receiving unit 1013 receives advertisement information transmitted from the advertisement delivery server 20 via the network 2, through the wireless communication unit 104.

The advertisement information output unit 1014 provides the received advertisement information to the user A, or the like, by outputting the advertisement information through the output unit 106.

The storage unit 102 includes a main memory and an auxiliary memory. The main memory is a memory in which programs to be executed by the control unit 101 and data to be utilized by the control programs are to be expanded. The auxiliary memory is a device in which programs to be executed by the control unit 101 and data to be utilized by the control programs are stored. In the auxiliary memory, programs to be executed by the control unit 101, which are packaged as application may be stored. Further, an operating system for executing this application may be stored. By the programs stored in the auxiliary memory being loaded to the main memory and executed by the control unit 101, the above-described processing is performed. Because the main memory and the auxiliary memory are similar to those of the storage unit 203, detailed description will be omitted.

The location acquiring unit 103 acquires the current location of the user terminal 10. Here, for example, the location acquiring unit 103 is constituted with a GPS unit which detects the current location of the user terminal 10 on the oasis of radio waves from a GPS satellite. A method for acquiring the current location of the user terminal 10 is not limited to the above-described method, and the current location of the user terminal 10 may be detected on the basis of arrival time of radio waves transmitted to the user terminal 10 from a plurality of wireless base stations with which the user terminal 10 performs wireless communication. Further, in the case where communication is performed using a wireless LAN, the current location of the user terminal 10 may be detected on the basis of strength of radio waves from a plurality of access points.

The wireless communication unit 104 is a wireless communication interface for connecting the user terminal 10 to the network 2. The wireless communication unit 104, for example, provides access to the network 2 via a wireless LAN or mobile communication service such as 3G and LTE.

The input unit 103 accepts input operation performed by the user A, or the like.

The output unit 106 is a unit for providing information to the user A, or the like, using an image, a video and speech.

In the present embodiment, a touch panel display which functions as the input unit 105 and the output unit 106 is used. That is, the input unit 105 is constituted with a liquid crystal display and its control means, a microphone which accepts speech input and speech processing means including a decoder which converts a speech signal into an electrical signal. Further, the output unit 106 is constituted with a touch panel and its control means, and a speaker and its control means.

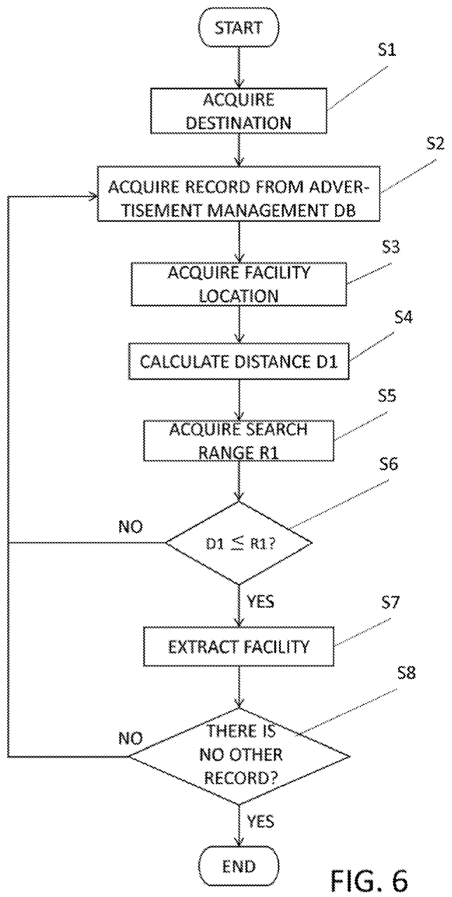

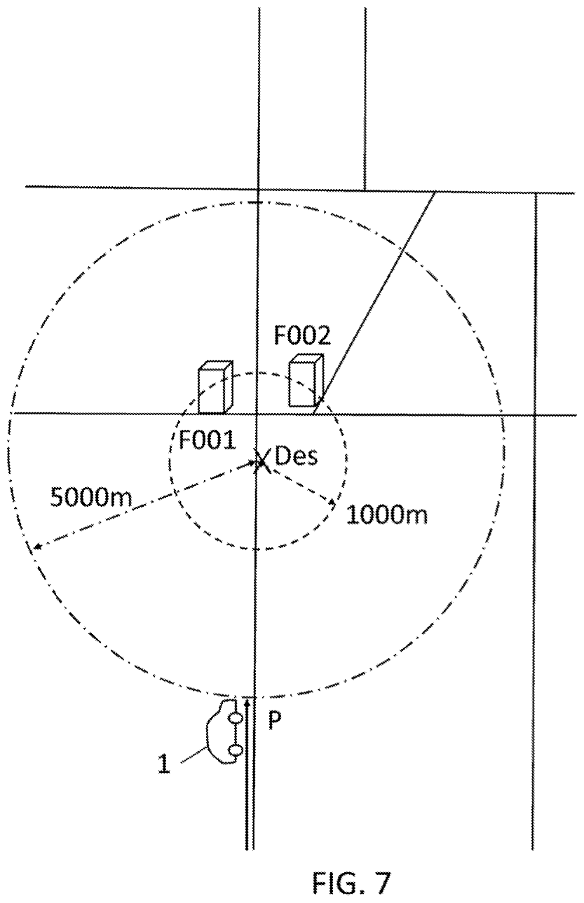

Facility extraction processing to be performed by the control unit 201 of the advertisement delivery server 20 will be described next on the basis of the flowchart in FIG. 6. Further, also referring to FIG. 7, the facility extraction processing will be specifically described using data stored in the tables illustrated in FIG. 3 and FIG. 4 as an example.

The facility extraction processing is processing of extracting a facility located in a predetermined search range from the destination of the user A, or the like, as a facility for which advertisement information is to be delivered to provide advertisement information which highly appeals to the user A, or the like.

First, in step S1, information relating to the destination of the user A (hereinafter, described using the user A as an example) is acquired from the ride sharing management database 2031. The destination (Des) of the user A which is expressed as (Lat_d_0, Lon_d_0) using the latitude and the longitude, is displayed as X in FIG. 7.

In step S2, one record of a facility is sequentially acquired from the advertisement management, database 2032. A record of a facility whose facility ID is F001 (hereinafter, also referred to as a facility F001) is acquired from the advertisement management information table 20321 illustrated in FIG. 4.

In step S3, information specifying a location of the facility is acquired from the record acquired in step S2. (Lat_f_0, Lon_f_0) stored in the facility location field of the record of the facility F001 in FIG. 4 is acquired. In FIG. 7, the facility F001 whose location is expressed as (Lat_f_0, Lon_f_0) is displayed.

In step S4, a distance D1 between the destination of the user A and the facility is calculated from the destination of the user A and the information specifying the location of the facility.

In step S5, information specifying a range in which a facility is to be searched for is acquired from the advertisement management database 2032. In the table illustrated in FIG. 4, 1000 stored in the search range field of the record of the facility F001 is acquired as the information specifying the range (R1) in which the facility is to be searched for. In FIG. 7, a circle indicating a range within a radius of 1000 meters centering around Des is displayed with a dashed line.

In step S6, through comparison between the distance D1 calculated in step S4 and a distance indicating the range in which the facility is to be searched for, acquired in step S5, it is judged whether or not D1≤R1.

In the case where it is judged in step S6 that the distance D1 calculated in step S4 exceeds the distance R1 acquired in step S5, the processing returns to step S2, and a record of the next facility in the advertisement management database 2032 is acquired, and processing in step S3 and subsequent steps is repeated.

In the case where it is judged in step S6 that the distance D1 calculated in step S4 is equal to or less than the distance indicating the range R1 in which the facility is to be searched for, acquired in step S5, the facility is extracted as a facility for which advertisement information is to be delivered in step S7.

In step S8, it is judged whether or not there are other records of facilities in the advertisement management database 2032.

In the case where it is judged in step S8 that there is no other record of a facility in the advertisement management, database 2032, the facility extraction processing is finished.

In the case where it is judged in step S8 that there are other records of facilities in the advertisement management database 2032, the processing returns to step S2, and the next record of a facility in the advertisement management database 2032 is acquired, and processing in step S3 and subsequent steps is repeated. Because there are other records of the facilities F002, F003, or the like, in the advertisement management information table 20321 illustrated in FIG. 4, processing in step S3 and subsequent, steps is performed on the record of the facility F002 next. As illustrated in FIG. 7, because a distance between a location of the facility F002 and the destination of the user A is also equal to or less than 1000 meters, the facility F002 is also extracted as the facility for which advertisement information is to be delivered in relation to the user A.

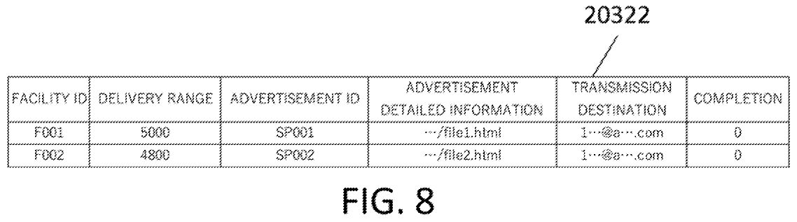

Through the facility extraction processing described above, a table of the target facility information 20322 for the facilities extracted as the facilities for which advertisement information is to be delivered in relation to the user A is generated in the advertisement management database 2032. FIG. 8 illustrates a configuration of the target facility information table 20322 generated in relation to the user A.

The target facility information table 20322 has a facility ID field, a delivery range field, an advertisement ID field, an advertisement detailed information field, a transmission destination field and a completion field. Among these, because the respective fields except the transmission destination field and the completion field are similar to those in the advertisement management information table 20321, description will be omitted.

In the transmission destination field, an address of the user terminal 10A of the user A to which the advertisement information is to be delivered is acquired from the ride sharing management information table 20311 and stored. In the table illustrated in FIG. 8, the address of 1. . .@a. . . .com of the user terminal 10A of the user A is stored.

In the completion field, data indicating whether or not transmission of the advertisement information to the user terminal 10A is completed is stored through advertisement, delivery processing which will be described later. In the completion field, 0 is stored as an initial value, and, in the case where transmission of the advertisement information to the user terminal 10A is completed, 1 is stored.

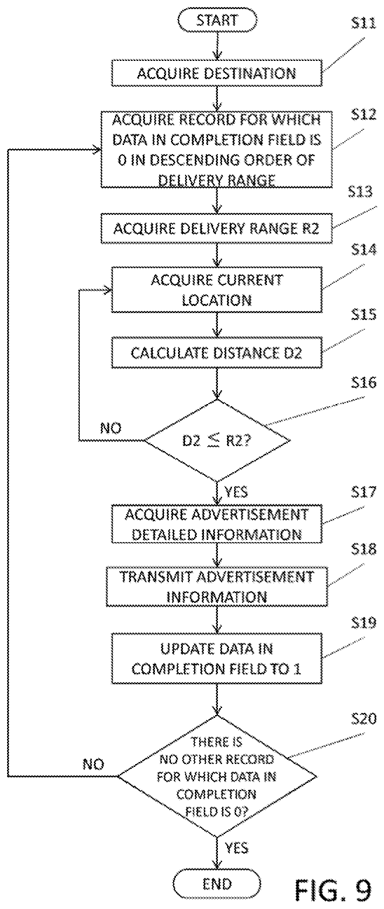

The advertisement delivery processing to be performed by the control unit 201 of the advertisement delivery server 20 will be described next on the basis of the flowchart in FIG. 9. The processing illustrated in FIG. 9 is to be performed on one user A. The advertisement delivery processing to be performed on the respective users A, B and C can be set as appropriate, for example, such that processing to be performed on a user for whom a distance between a departure place and a destination is shorter is prioritized. Further, by also referring to FIG. 7, the advertisement delivery processing will be specifically described using data stored in the tables illustrated in FIG. 3 and FIG. 4 as an example. Here, a series of processing including the facility extraction processing illustrated in FIG. 6 and the advertisement delivery processing illustrated in FIG. 9 correspond to an information processing method according to the present embodiment.

The advertisement delivery processing is processing of providing advertisement information for the facilities extracted in the facility extraction processing at a more effective timing which is likely to make an impression on the user who approaches the destination. Because it is sufficient to start this processing after the vehicle 1 starts moving, for example, the processing may be started in the case where a change amount of the current location of the user terminal 10 exceeds a predetermined threshold. Further, it is also possible to determine a distance for starting which exceeds a delivery range from the destination of the user A. and start the processing in the case where a distance from the destination to the current location of the user terminal 10A becomes equal to or less than the distance fox starting.

First, in step S11, information relating to the destination of the user A is acquired from the ride sharing management database 2031. Also in the following description, description will be provided using the user A as an example in accordance with FIG. 7. As described above, in FIG. 7, the destination (Des) of the user U001 is displayed as X.

Then, in step S12, records of facilities whose data in the completion field is 0 are acquired from the target facility information table 20322 in descending order of value in the delivery range field. In the target facility information table 20322 illustrated in FIG. 8, data in the completion field for both the facilities F001 and F002 is 0. Because the value in the delivery range field of the facility F001 is 5000, and the value in the delivery range field of the facility F002 is 4300, a record of the facility F001 is acquired first. Here, in the case where data in the delivery range field is the same among a plurality of facilities, processing is performed in appropriate order such as ascending order of facility ID.

In step S13, data R2 in the delivery range field is acquired among the record of the facility F001 acquired in step S12. In the target facility information table illustrated in FIG. 8, data in the delivery range field is 5000. In FIG. 7 a circle indicating a range within a radius of 5000 meters centering around Des is displayed with a dot-and-dash line.

In step S14, the current location of the user terminal 10A is acquired from the ride sharing management database 2031 Here, (Lat_p_0, Lon_p_0) stored in the current location field of the record of the user A in the ride sharing management database 2031 illustrated in FIG. 3 is acquired. A location P specified with latitude and longitude of (Lat_p_0, Lon_p_0) is displayed in FIG. 7 as a location of the vehicle 1 on which the user A shares a ride.

In step S15, a distance D2 between the destination acquired in step S11 and the current location of the user terminal acquired in step S14 is calculated.

In step S16, through comparison between a distance R2 indicating the delivery range acquired in step S13 and the distance D2 calculated in step S15, it is judged whether or not D2≤R2.

In the case where it is judged in step S16 that the distance D2 calculated in step S15 exceeds the distance R2 acquired in step S13, the processing returns to step S14, and processing in step S15 and subsequent steps is repeated on the updated location of the user terminal.

In the case where it is judged in step S16 that the distance D2 calculated in step S15 is equal to or less than the distance R2 acquired in step S13, advertisement, detailed information relating to the facility is acquired from the target facility information table 20322. Because, in FIG. 7, the current location of the user U001 reaches a point at 5000 meters from Des, and a distance between the destination of the user A and the current location P of the user terminal 10A is equal to or less than 5000 meters, fill name of . . ./file1.html stored in the advertisement detailed information field of the record of the facility F001 is acquired.

In step S18, advertisement information corresponding to the advertisement detailed information acquired in step S16 is transmitted to the user terminal 10A. In FIG. 7, a file of . . . /file1.html acquired in step S15 is transmitted to the user terminal of the user U001 specified by an address of 1. . .@a. . . .com via the network, and output to the output unit of the user terminal.

In step S19, data in the completion field of the record of the facility for which the advertisement information has been transmitted is updated to 1.

In step S20, it is judged whether or net there are other records of facilities for which data in the completion field is 0 in the target facility information table 20322. In the case where it is judged in step S20 that there are other records of facilities for which data in the completion field is 0 in the target facility information table 20322, the processing returns to step S12. In step S12, a record for which data in the delivery range field is greater among the records of facilities for which data in the completion field is 0 is acquired, and processing in step S13 and subsequent steps is performed.

As described above, in the first embodiment, advertisement information of facilities located within a predetermined range from the destination is transmitted to the user terminal 10 of the user A, or the like, when the user A, or the like, moves within a predetermined range from the destination. Therefore, according to the first embodiment, it is possible to deliver advertisement information while narrowing down targets to users who are highly likely to utilize the facilities, and it is possible to deliver advertisement information at a timing which is impressive to the users who are headed toward the destinations, so that it is possible to provide advertisement information to the users more effectively.

### Second Embodiment

In the present embodiment, related facilities located within a third range including a moving route of the user are extracted, and, in the case where the current location of the user terminal is located within a fourth range including the extracted related facilities on the route leading to the destination from the departure place of the user, advertisement information is transmitted to the user terminal. Here, the third range corresponds to the second search range for the facility, and corresponds to the search range for the related facility. Further, the fourth range corresponds to the second delivery range for the facility, and corresponds to the delivery range for the related facility.

Because a schematic configuration of the advertisement delivery system according to the present embodiment is similar to the configuration in the first embodiment illustrated in FIG. 1, description will be omitted. Because a configuration of the user terminal 10 according to the present embodiment is also similar to the configuration of the user terminal 10 according to the first embodiment, description of common components will be omitted.

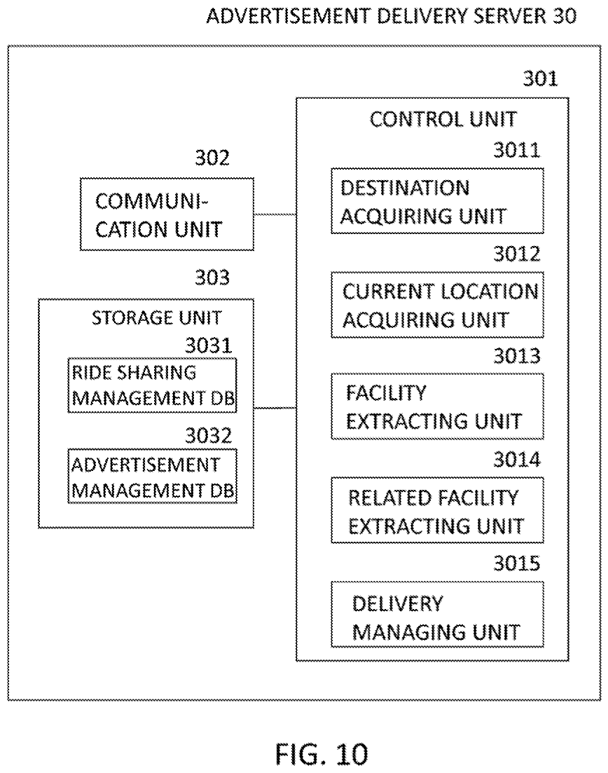

FIG. 10 illustrates a system configuration of the advertisement delivery server 30 according to the present embodiment. The advertisement delivery server includes a communication unit 302, a storage unit 303 and a control unit 301. Because hardware configurations of the communication unit 302, the storage unit 303 and the control, unit 301 are similar to those in the first embodiment, description will be omitted.

The storage unit 303 stores a ride sharing management database 3031 and an advertisement management database 3032.

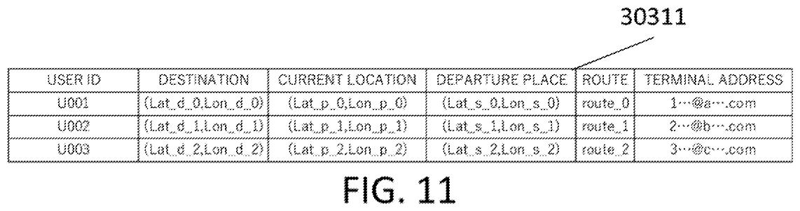

A table configuration of the ride sharing management information 30311 of the users stored in the ride sharing management database 3031 according to the present embodiment will be described with reference to FIG. 11. FIG. 11 is a diagram illustrating an example of the table configuration of the ride sharing management information 30311 of the users A, B and C stored in the ride sharing management database 3031. The ride sharing management information table 30311 has a departure place field and a route field in addition to a user ID field, a destination field, a current location field and a terminal address field. Because the user ID field, the destination field, the current location field and the terminal address field are similar to those in the first embodiment, description will be omitted.

In the departure place field, information relating to departure places of the user A, or the like, in ride sharing is stored. The departure places are expressed with latitude and longitude.

In the route field, information specifying routes from the departure places to the destinations of the user A, or the like, in ride sharing is stored. The information specifying the routes is, for example, specified with nodes and links, and is expressed in a form from which distances from surrounding facilities can be calculated. In FIG. 11, route_0 is stored as the information specifying the route of the user A.

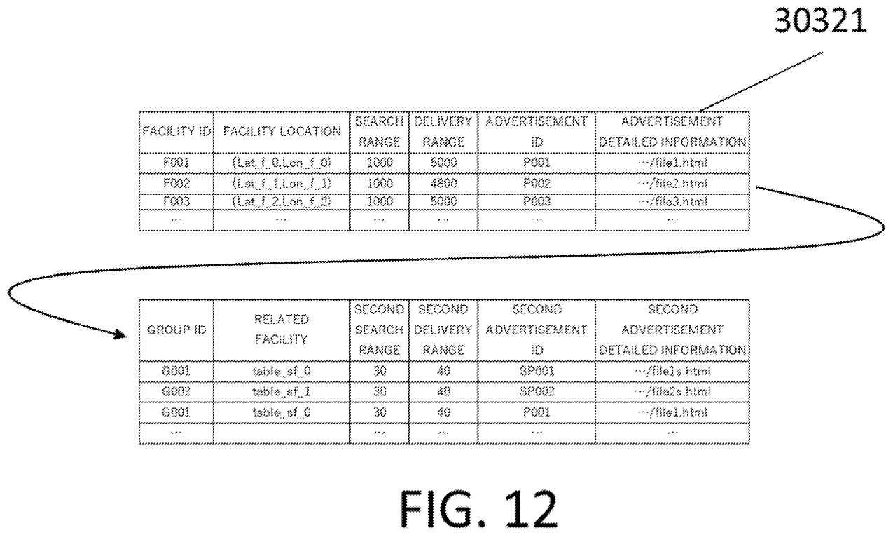

The advertisement management database 3032 according to the present embodiment includes an advertisement management information table 30321 and a related facility information table 30322. A table configuration of the advertisement management information 30321 will be described with reference to FIG. 12. FIG. 12 is a diagram illustrating an example of the table configuration of the advertisement, management, information 30321 stored in the advertisement management database 3032. The advertisement management information table 30321 has a facility ID field, a facility location field, a search range field, a delivery range field, an advertisement ID field and an advertisement detailed information field in a similar manner to the advertisement management information table 20321. The advertisement management information table 30321 has a group ID field, a related facility field, a second search range field, a second delivery range field, a second advertisement ID field and a second advertisement detailed information field in addition to these. Because the facility ID field, the facility location field, the search range field, the delivery range field, the advertisement ID field and the advertisement detailed information field are similar to those in the first embodiment, description will be omitted.

In the group ID field, group IDs are stored, which are identification information for specifying groups, each group including facilities which are registered in the advertisement management information table 30321 and which correspond to related facilities from each other. For example, facilities which can ail fall within search targets in relation to the destination of the user, such as stores belonging to the same chain, and facilities in relationship of a main shop and a branch shop, or main office and branch office, belong to the same group, and the same group ID is provided. In the case where the related facilities are not registered in the advertisement management Information table 30321, and a group is not formed, for example, G is stored in the group ID field. In FIG. 12, G001, G002 and G001 are respectively stored in the group ID fields of the facilities F001, F002 and F003. Here, the facilities F001 and F003 belong to the same group.

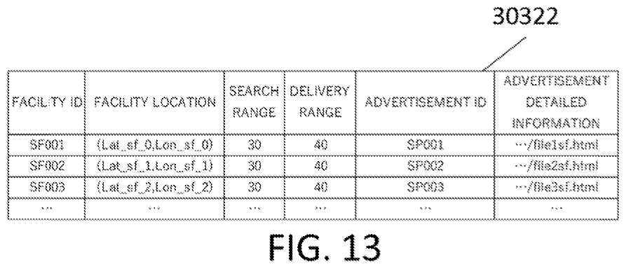

In the related facility field, related facility information table IDs are stored, which are identification information for specifying the related facility information tables 30322 in which information relating to the related facilities not registered in the advertisement management information table 30321 is stored. The related facilities not registered in the advertisement management information table 30321 include, for example, a sign of the facility, an information board on which the facility is displayed, or the like. In the case where there is no related facility not registered in the advertisement management information table 30321, for example, 0 is stored in the related facility field. In FIG. 12, table_sf_0 is stored as the related facility information table ID of the facility F001. The related facility information table 30322 specified by this related facility information ID is the table having the table configuration illustrated in FIG. 13.

In the second search range field, information specifying ranges in which related facilities for which advertisement information is to be delivered are to be searched for, that is, the third range, is stored in relation to routes from the departure places to the destinations of the user A, or the like. Because a facility which is a target of the record is searched for as a related facility of another facility registered in the advertisement management information table 30321, the facility will be referred to as a related facility. Here, the ranges to be searched for are expressed with distances from a route from the departure places to the destinations of the users. In FIG. 12, 30 is stored in the second search range of the facility F001.

In the second delivery range field, information specifying ranges in which advertisement information is to be delivered to the user terminal 10 in relation to the current locations of the user A, or the like, that is, the fourth range is stored. Here, the ranges in which advertisement information is to be delivered are expressed with distances to the related facilities. In FIG. 12, 40 is stored in the second delivery range field of the facility F003.

Data stored in the second advertisement ID field and the second advertisement detailed information field is similar to that in the advertisement ID field and the advertisement detailed information field of the advertisement management information table 20321. In FIG. 12, P001 and . . ./file1.html are respectively stored in the second advertisement ID field and the second advertisement detailed information field of the facility F003. That is, the advertisement information to be delivered in the case where F003 becomes the related facility for which an advertisement is to be delivered is the same as the advertisement ID and the advertisement detailed information of the facility F001.

A configuration of the related facility information table 30322 will be described with reference to FIG. 13. The related facility information table 30322 is provided for each facility registered in the advertisement management information table 30321. The related facility information table 30322 has a facility ID field, a facility location field, a search range field, a delivery range field, an advertisement ID field and an advertisement detailed information field.

In the facility ID field, facility IDs which are identification information for specifying the related facilities are stored. In FIG. 13, SF001, SF002, SF003, or the like, are stored as the facility IDs.

In the facility location field, information specifying locations of the related facilities is registered. Here, the locations of the related facilities are expressed with latitude and longitude. In FIG. 13, (Lat_sf_0, Lon_sf_0) is stored as the location of the facility SF001.

In the search range field, information specifying ranges in which related facilities for which advertisement information is to be delivered are to be searched for in relation to a route from the departure place to the destination of the user A, that is, the third range, is stored. Here, the ranges in which the related facilities are to be searched for are expressed with a distance from a route from the departure place to the destination of the user A. In FIG. 13, 30 is stored in the search range field of the facility SF001.

In the delivery range field, information specifying ranges in which advertisement information is to be delivered to the user A in relation to the current location of the user terminal 10A, that is, the fourth range, is stored. Here, the ranges in which the advertisement information is to be delivered are expressed with distances to the related facilities. In FIG. 13, 40 is stored in the delivery range field of the related facility SF001.

Data stored in the advertisement ID field and the advertisement detailed information field is similar to that in the case of the advertisement management information table 30321. In FIG. 13, SP001 and . . ./file1sf.html are respectively stored in the advertisement ID field and the advertisement detailed information field of the facility SF001.

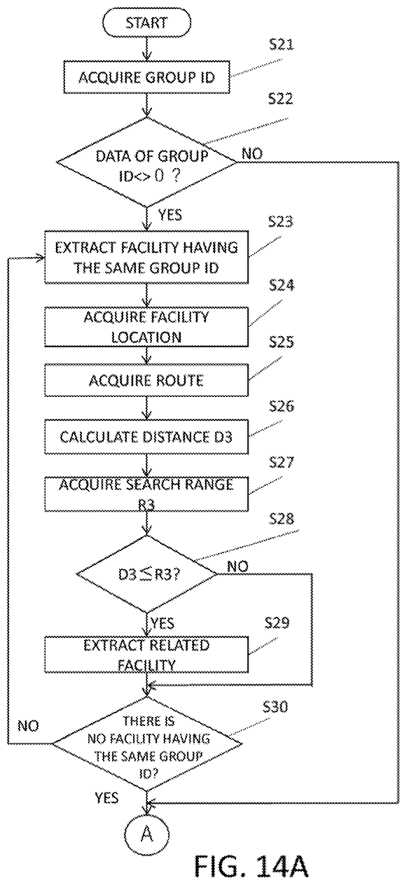

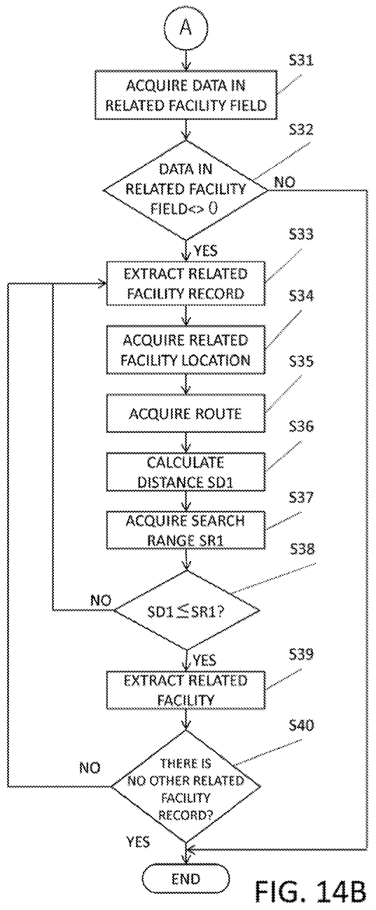

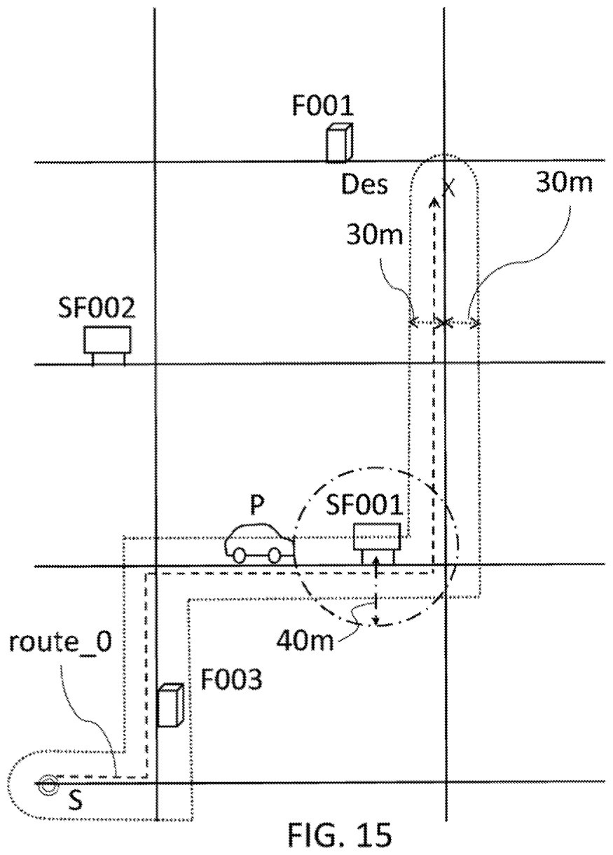

Related facility extraction processing to be performed by the control unit 301 of the advertisement delivery server 30 will be described next on the basis of flowcharts in FIG. 14A and FIG. 14B. Further, also referring to FIG. 15, the related facility extraction processing will be specifically described using the data stored in the tables illustrated in FIG. 11, FIG. 12 and FIG. 13 as an example.

First, in step S21, information in the group ID field is acquired from the advertisement management information table 30321. In the following description, the user A and the facility F001 will be described as an example in accordance with FIG. 15. In the record of the facility F001 illustrated in FIG. 12, G001 is stored in the group ID field.

In step S22, it is judged whether or not data in the group ID field is 0.

In the case where it is judged in step S22 that the data in the group ID field is 0, the processing proceeds to step S31.

In the case where it is judged in step S22 that the data in the group ID field is not 0, in step S23, one facility according to the record in which a group ID which is the same as the group ID stored in the group ID field of the record is stored is extracted. In the advertisement management information table 30321 illustrated in FIG. 12, because the group ID of the facility F003 is the same as the group ID of the facility F001, the facility F003 is extracted.

In step S24, information specifying a location of the facility is acquired from the record of the facility extracted in step S23. In FIG. 12, the location of the facility F003 is expressed as (Lat_f_3, Lon_f_3). In FIG. 15, this facility F003 is displayed.

In step S25, a route from the departure place to the destination of the user A is acquired from the ride sharing management database. From the ride sharing management information table 30311 illustrated in FIG. 11, route_0 which is stored as the route from the departure place to the destination of the user A is acquired. In FIG. 15, the route route_0 from the departure place S (displayed with a double circle) to the destination Des is displayed with a dashed line.

In step S26, a distance D3 between the route from the departure place to the destination of the user A and the facility is calculated from the route from the departure place to the destination of the user A and information specifying the location of the facility.

In step S27, information R3 specifying a range in which the related facility is to be searched for, stored in the second search range field is acquired from a record of the facility extracted in step S23. In FIG. 12, 30 is stored in the second search range field of the facility F003. In FIG. 15 a range within 30 meters from the route route_0 is displayed with a dotted line.

In step S28, through comparison between the distance D3 calculated in step S26 and the distance R3 indicating the range in which the related facility is to be searched for, acquired in step S28, it is judged whether or not D3≤R3.

In the case where it is judged in step S28 that the distance D3 calculated in step S26 exceeds the distance R3 indicating the range in which the related facility is to be searched for, acquired in step S28, the processing proceeds to step S30.

In the case where it is judged in step S28 that the distance D3 calculated in step S26 is equal to or less than the distance R3 indicating the range in which the related facility is to be searched for, acquired in step S28, in step S29, the facility is extracted as a related facility for which advertisement information is to be delivered. As illustrated in FIG. 15, a distance from the facility F003 to the route route_0 is equal to or less than 30 meters. Therefore, the facility F003 is extracted as the related facility.

In step S30, it is judged whether or not there are other records in which the same group ID is stored in the advertisement management information table 30321.

In the case where it is judged in step S30 that there is no other record in which the same group ID is stored in the advertisement management information table 30321, the processing proceeds to step S31. Because there is no other record of a facility having the group ID of G001 in the advertisement management information table 30321 illustrated in FIG. 12, the processing proceeds to step S31.

In the case where it is judged in step S30 that there are other records in which the same group ID is stored in the advertisement management information table 30321, the processing returns to step S23, a facility according to one record in which the same group ID is stored is extracted, and processing in step S24 and subsequent steps is performed.

In step S31, data in the related facility field is acquired from the advertisement management information table 30321. In the record of the facility F001 in the advertisement, management information table 30321 illustrated in FIG. 12, table_sf_0 is stored in the related facility field.

In step S32, it is judged whether or not data in the related facility field is 0.

In the case where it is judged in step S32 that the data in the related facility field is 0, the related facility extraction processing is finished.

In the case where it is judged in step S32 that the data in the related facility field is not 0, in step S33, a related facility according to one record is extracted from the related facility information table 30322 specified by the related facility information ID stored in the related facility field. As described above, the related facility information table 30322 specified by table_sf_0 acquired from the advertisement management information table 30321 illustrated in FIG. 12 is the table illustrated in FIG. 13. Therefore, a related facility whose facility ID is SF001 (hereinafter, also referred to as a related facility SF001) is extracted from this related facility information table 30322. For comparison, a related facility SF002 stored in the same table will be also described.

In step S34, information specifying a location of the related facility is acquired from a record of the related facility SF00 extracted in step S32. (Lat_sf_0, Lon_sf_0) which is latitude and longitude indicating the location of the facility SF001 is acquired from the related facility information table 30322 illustrated in FIG. 13.

In step S35, a route from the departure place to the destination of the user A is acquired from the ride sharing management information table 30311. Here, route_0 stored as the route from the departure place to the destination of the user A is acquired from FIG. 11. In FIG. 15, as described above, this route_0 is displayed with a dashed line.

In step S36, a distance SD1 between the route from the departure place to the destination of the user A and the related facility is calculated from the route from the departure place to the destination of the user A and the information specifying the location of the related facility.

In step S37, information SR1 specifying a range in which the related facility is to be searched for, stored in the search range field is acquired from a record of the related facility SF001 extracted in step S34. Here, as illustrated in FIG. 13, 30 stored in the search range field of the facility SF001 is acquired. Note that data stored in the search range field of the facility SF002 is 30.

In step S38, through comparison between the distance calculated in step S36 and the distance SR3 indicating the range in which the related facility is to be searched for, acquired in step S37, it is judged whether or not SD1≤SR1.

In the case where it is judged in step S38 that the distance SD1 calculated in step S36 exceeds the distance SR1 indicating the range in which the related facility is to be searched for, acquired in step S37, the processing returns to step S33. Here, for the facility SF002 taker, as an example for comparison, as illustrated in FIG. 15, because a distance from the route route_0 to the facility SF002 exceeds 30 meters, the facility SF002 is not extracted as the related facility in relation to the user U001.

In the case where it is judged in step S38 that the distance SD1 calculated in step S36 is equal to or less than the distance SR1 indicating the range in which the related facility is to be searched for, acquired in step S37, in step S39, the related facility is extracted as a related facility for which advertisement information is to be delivered. As illustrated in FIG. 15, because a distance from the route route_0 to the facility SF001 is equal to or less than 30 meters, the facility SF001 is extracted as the related facility.

In step S40, it is judged whether or not there are other records in the related facility information table 30322.

In the case where it is judged in step S40 that there is no other record in the related facility information table 30322, the related facility extraction processing is finished.

In the case where it is judged in step S40 that there are other records in the related facility information table 30322, the processing returns to step S33, and related facilities according to the other records are extracted from the related facility information table 30322, and processing in step S34 and subsequent steps is performed. Because there are other records of SF002, SF003, or the like, in table_sf_0 illustrated in FIG. 13, the processing returns to step S33.

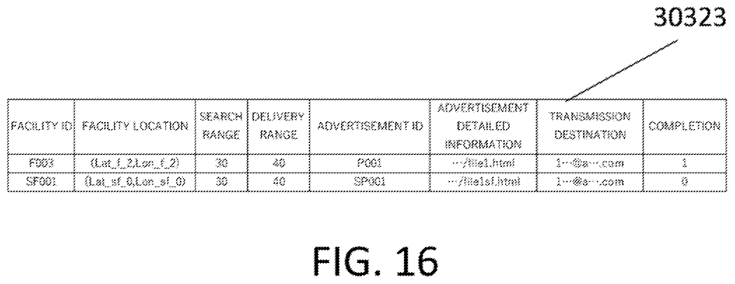

Through the related facility extraction processing described above, the target related facility information table 30323 for the related facilities extracted as the related facilities for which advertisement information is to be delivered in relation to the user A is generated in the advertisement management database 3032. FIG. 16 illustrates a configuration of the target related facility information table. The target related facility information table 30323 has a facility ID, a facility location field, a search range field, a delivery range field, an advertisement ID field, an advertisement detailed information field, a transmission destination field, and a completion field. For the facilities registered in the advertisement management information table 30321, information stored in the facility ID field, the facility location field, the second search range field, the second delivery range field, the second advertisement ID field and the second advertisement detailed information field is respectively stored in the facility ID, the facility location field, the search range field, the delivery range field, the advertisement ID field and the advertisement detailed information field of the target related facility information table 30323. For the related facilities registered in the related facility information table 30322, the facility ID field, the facility location field, the search range field, the delivery range field, the advertisement ID field and the advertisement detailed information field are respectively stored in the facility ID field, the facility location field, the search range field, the delivery range field, the advertisement ID field and the advertisement detailed information field of the target related facility information table 30323. Here, because the facility is the related facility extracted as the related facility for which advertisement information is to be delivered in relation to the user A, the terminal address of the user A is stored in the transmission destination field. In the completion field, data indicating whether or not transmission of advertisement information to the user terminal is completed is stored through advertisement delivery processing which will be described later. In the completion field, 0 is stored as an initial value, and 1 is stored in the case where delivery of advertisement information is completed.

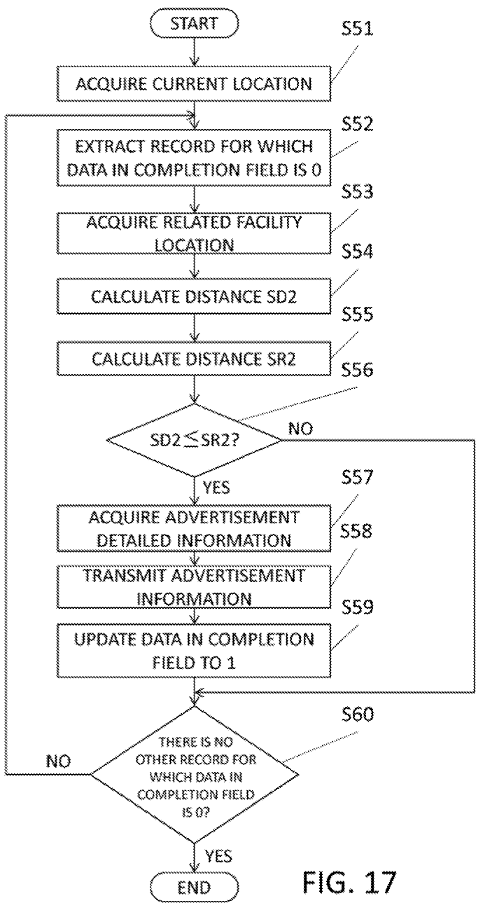

Advertisement delivery processing relating to the related facilities to be performed by the control unit 301 of the advertisement delivery server 30 will be described next on the basis of a flowchart in FIG. 17. Further, also referring to FIG. 15, the advertisement delivery processing will be specifically described using data stored in the target related facility information table 30323 in FIG. 16 as an example.

By the advertisement delivery processing relating to the related facilities being performed so that advertisement information is provided by being triggered by the related facilities on the route from the departure place to the destination of the user, it is possible to increase an opportunity that the user has contact with advertisement information relating to the facilities, so that an appealing effect is increased. Further, there is also a possibility that advertisement information is provided while the user visually confirms the related facilities, so that it is possible to give a stronger impression of the advertisement information on the user. Because it is sufficient to start this processing after the vehicle starts moving, the processing may be started, for example, in the case where a change amount of the current location of the user terminal exceeds a predetermined threshold. Further, it is also possible to determine a distance for starting which exceeds a delivery range from the destination of the user, and start the processing in the case where the distance from the destination to the current location of the user terminal becomes equal to or less than the distance for starting.

First, in step S51, the current, location of the user terminal 10A is acquired from the ride sharing management information table 30311. (Lat_p_0, Lon_p_0) stored in the current location field of the ride sharing management information table 30311 is acquired. The current location (P) of the user A displayed with latitude and longitude of (Lat_p_0, Lon_p_0) is displayed as the vehicle 1 on which the user A shares a ride in FIG. 15. The vehicle 1 on which the user A shares a ride travels along the route route_0, passes through the delivery range of the facility F003 and approaches the facility SF001.

In step S52, one record of the related facility for which data in the completion field is 0 is extracted from the target related facility information table 30323. In the target related facility information table 30323 illustrated in FIG. 16, because the data in the completion field of the facility F003 is updated to 1, a record of the related facility SF001 is extracted.

In step S53, information specifying a location of the related facility stored in the facility location field of the extracted record of the related facility is acquired. In the target related facility information table 30323 illustrated in FIG. 16, (Lat_sf_0, Lon_sf_0) stored in the facility location field of the facility SF001 is acquired. In FIG. 15, SF001 is displayed at a location specified with latitude and longitude

In step S54, a distance SD2 between the current location of the user terminal 10A acquired in S51 and the location of the related facility SF001 acquired in S53 is calculated.

In step S55, information SR2 specifying the range in which advertisement information is to be delivered, stored in the delivery range field of the record of the extracted related facility SF001 is acquired. In the target related facility information table 30323 illustrated in FIG. 16, 40 is stored in the delivery range field of the facility SF001. In FIG. 15, a circle indicating a range within 40 meters from the facility SF001 is indicated with a dot-and-dash line.

In step S56, it is judged which is longer, the distance SD2 calculated in step S54 or the distance SR3 indicating the delivery range acquired in step S55 through comparison.

In the case where it is judged in step S56 that the distance calculated in step S54 exceeds the distance indicating the delivery range acquired in step S55, the processing proceeds to step S59.

In the case where it is judged in step S56 that the distance calculated in step S54 is equal to or less than the distance indicating the delivery range acquired in step S55, the processing proceeds to step S57. In step S57, advertisement detailed information relating to the related facility SF001, stored in the advertisement detailed information field of the extracted related facility SF001 is acquired. . . ./file1sf.html stored in the advertisement detailed information field of the target, related facility information table 30323 illustrated in FIG. 16 is acquired. As illustrated in FIG. 15, the current location P of the user terminal IDA of the user A reaches a point at 40 meters from the location of the SF001, and a distance between the current location of the user terminal 10A and the location of the SF001 is equal to or less than 40 meters. Therefore, at this time, file name of . . ./field1sf.html stored in the advertisement detailed information field is acquired.

In step S58, advertisement information corresponding to the advertisement detailed information acquired in step S57 is transmitted to the user terminal. In FIG. 15, a file of . . . file1sf.html acquired in step S58 is transmitted to the user terminal 10A of the user A, and output from the output unit 106.

In step S59, for a record of the facility for which advertisement information is delivered, data in the completion field is updated to 1. In the example illustrated in FIG. 15, in the target related facility information table 30323 illustrated in FIG. 16, data in the completion field of the record of the facility SF001 is updated to 1.

In step S60, it is judged whether or not there are other records of related facilities for which data in the completion field is 0 in the target related facility information table 30323.

In the case where it is judged in step S60 that there is no other record of a related facility for which data in the completion field is 0 in the target related facility information table 30323, the advertisement delivery processing is finished. In the example illustrated in FIG. 15, in the target related facility information table 30323 illustrated in FIG. 16, data in the completion field of the record of the facility SF001 is updated to 1, and, because there is no other record of a related facility for which data in the completion field is 0, the advertisement delivery processing is finished. In the case where it is judged in step S60 that there are other records of related facilities for which data in the completion field is 0 in the target related facility information table 30323, the processing returns to step S52, and one record of the related facility for which data in the completion field is 0is extracted, and processing in step S53 and subsequent steps is performed.

As described above, according to the second embodiment, by delivering advertisement information also during movement to the destination by taking an opportunity that the user moves near related facilities, it is possible to increase an opportunity that the user has contact with the advertisement information, and because there is also a possibility that the advertisement information is provided while the user visually confirms the related facilities, it is possible to provide a stronger impression of the advertisement information on the user, so that it is possible to provide the advertisement information more effectively.

### Third Embodiment

In the present embodiment, a request indicating that a user does not desire delivery of advertisement information is accepted from the user, and advertisement information is not transmitted to a user terminal of the user who does not desire delivery of advertisement information.

Because configurations of the advertisement delivery servers 20 and 30 and the user terminal 10 according to the present embodiment are similar to those in the first embodiment or the second embodiment, description of common components will be omitted.

FIG. 13 illustrates a table configuration of ride sharing management information 40311 stored in a ride sharing management database 4031 according to the present embodiment. Because a configuration is similar to the ride sharing management information table 20311 according to the first embodiment except that a delivery rejection field is provided, description of common components will be omitted.

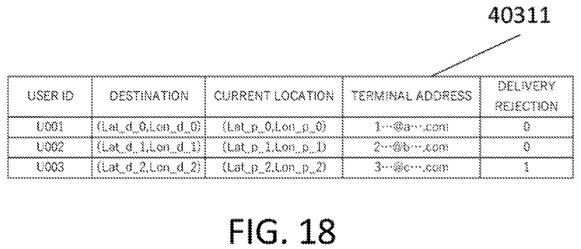

In the delivery rejection field, 0 is stored as an initial value, and data is updated to 1 in the case where the user does not desire delivery of advertisement information. In the example illustrated in FIG. 18, the users A and B desire delivery of advertisement information, and the user C does not desire delivery of advertisement information.

To accept a request indicating that the user does not desire delivery of advertisement information, a screen for accepting a request indicating that the user does not desire delivery of advertisement information is displayed at the input unit 105 of the user terminal 10. In the case where a request indicating that the user does not desire delivery of advertisement information is accepted from the user through the screen, data in the delivery rejection field of the ride sharing management information table 40311 is updated to 1.

The screen for accepting a request indicating that the user does not desire delivery of advertisement information may be displayed when the user A, or the like, input information relating to ride sharing from the user terminal 10 or may be displayed during movement from a departure place to a destination. Further, an icon which encourages display of the screen for accepting a request indicating that the user does not desire delivery of advertisement information may be displayed at part of advertisement information.

Before facility extraction processing and advertisement delivery processing, data in the delivery rejection field is acquired, and in the case where the data is 0, respective processing is started, while, in the case where the data is 1, the respective processing is not performed.

As described above, according to the third embodiment it is possible to avoid delivery of advertisement information for which an effect is less expected, so that it is possible to provide comfortable ride sharing in accordance with desire of users also to users who feel that advertisement information is annoying.

### Modified Example of the Third Embodiment

In the case where a request indicating that the user does not desire delivery of advertisement information is accepted from the user A, or the like, a request indicating that the user does not desire delivery of part of advertisement information may be accepted as well as a request indicating that the user does not desire delivery of ail advertisement information.

For example, a request indicating that the user does not desire delivery of advertisement information of facilities other than restaurants may be accepted. In this case, in the delivery rejection field, information specifying a category of facilities for which delivery of advertisement information is not desired is stored. Then, in the advertisement management information table and the related facility information table, a field in which information specifying a category of each facility is stored is provided. In the facility extraction processing and the advertisement delivery processing, facilities corresponding to the information stored in the delivery rejection field are excluded from targets of extraction and delivery of advertisement.

According to this, by allowing delivery of advertisement information for part of facilities, it is possible to secure an opportunity of providing advertisement information for the allowed facilities, so that an advertisement effect is high in addition to a case where merely a request indicating that the user does not desire all delivery is accepted. Further, for the users, it is possible to make a choice as to advertisement information to be received, so that it is possible to respond to desire of the users more sensitively.

### Fourth Embodiment

In the present embodiment, by the user causing advertisement information which is to be delivered to the user, to be delivered to other users who share a ride, it is possible to share advertisement information with the other users.

Because configurations of the advertisement delivery servers 20 and 30 and the user terminal 10 according to the present embodiment are similar to those in the first embodiment to the third embodiment, description of common components will be omitted.

In a ride sharing management information table 50311 of a ride sharing management database 5031 according to the present embodiment, a sharing field in which information indicating whether or not advertisement information is to be shared for each of other users who share a ride is stored, is provided.

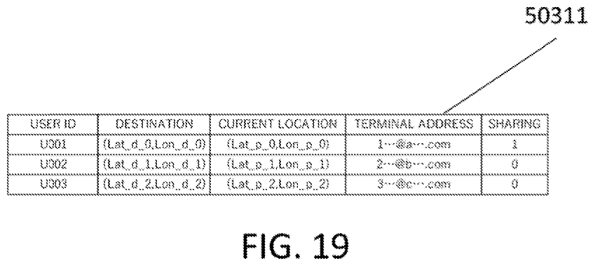

FIG. 19 illustrates the ride sharing management information table 50311 according to the present embodiment. 0 is stored as an initial value in the sharing field, and, in the case where the user desires to share advertisement information with the user, data in this field is updated to 0. In the example illustrated in FIG. 19, the user A desires delivery of advertisement information which is to be delivered to the user A, also to other users B and C who share a ride. Meanwhile, the users B and C do not desire delivery of advertisement information which is to be delivered to the users B and C, also to other users A and C, and A and B who share a ride.

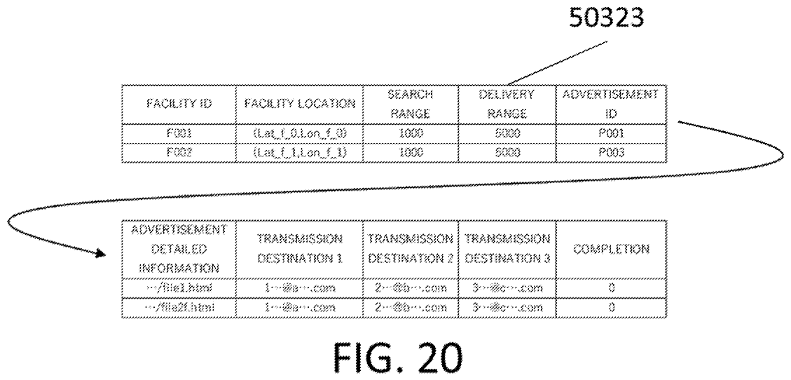

A target facility information table 50322 according to the present embodiment is illustrated in FIG. 20. The user A desires delivery of advertisement information which is to be delivered to the user A, also to the users B and C. Therefore, in the target facility information table 50322, three fields of a transmission destination 1 field, a transmission destination 2 field and a transmission destination 3 field are provided as transmission destinations of advertisement information for the facilities F001 and F002 extracted in relation to the destination of the user A. In these fields, addresses of the user A, the user B and the user C are respectively stored.

In facility extraction processing and advertisement delivery processing relating to the user A who becomes a target, data in the sharing field is acquired. In the case where the data is 0, the transmission destination of the advertisement information to be delivered to the user who becomes a target is merely the user terminal 10A. Then, in the case where the data is 1, user terminals 10B and 10C of other users are added to the transmission destination of advertisement information to be delivered to the user who becomes a target.

As described above, according to the fourth embodiment, by the users who share a ride having contact with common advertisement information, it is possible to encourage communication among the users and allow the users to enjoy ride sharing. Further, for facilities, advertisement information is spread from the user who is a target, and users who have contact with the advertisement information increases, so that it is possible to provide the advertisement information more effectively.

### Fifth Embodiment

In the present embodiment, incentives for receiving advertisement information are provided to users.

Because configurations of the advertisement delivery servers 20 and 30 and the user terminal 10 according to the present embodiment are similar to those in the first embodiment to the fourth embodiment, description of common components will be omitted.

In a ride sharing management, information table 60311 of the ride sharing management database 6031 according to the present embodiment, a delivery result field is provided.

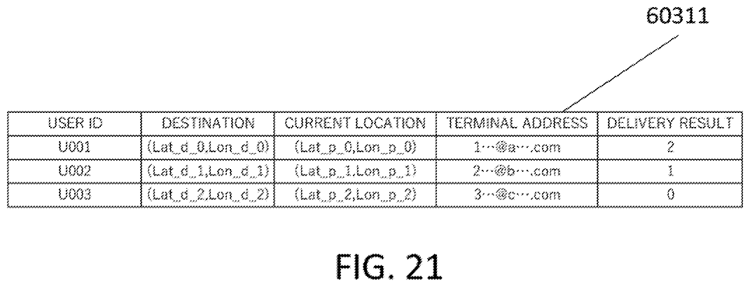

FIG. 21 illustrates a ride sharing management information table 60311 according to the present embodiment. In the delivery result field, data in accordance with transmission results of advertisement information to the user terminal of the user who becomes a target is stored. In the delivery result, field, 1 is stored as an initial value, in the case where delivery of advertisement information is not desired, the data is updated to 0, and, in the case where advertisement information is caused to be delivered also to other users, the data is updated to 2. Here, transmission results of advertisement information correspond to provision history.

In accordance with data in the delivery rejection field illustrated in FIG. 18, while the user A and the user B desire delivery of advertisement information, the user C does not desire delivery of advertisement information. In accordance with data in the sharing field illustrated in FIG. 19, while the user A desires delivery of advertisement information which is to be delivered to the user A, also to other users, the user B and the user C do not desire delivery of advertisement information which is to be delivered to the user B and the user C, also to other users. At this time, as in the ride sharing management information table illustrated in FIG. 21, data is 2 in the delivery result field of the record of the user A, data is 1 in the delivery result field of the record of the user B, and data is 0 in the delivery result field of the user C.

In accordance with the data stored in the delivery result field, a coupon which can be utilized in facilities for which are objects of advertisement is issued as a privilege. Further, a discount rate for cost of ride sharing may be set as a privilege in accordance with the data stored in the delivery result field. Still further, it is also possible to reflect the data stored in the delivery result field in points for a privilege to be registered in a database which is separately provided and which manages user information.

As described above, according to the present embodiment, because the user can receive an additional privilege as well as obtaining information, it is possible to further improve an advertisement effect.

### Modified Examples

The above-described embodiments are merely examples, and the present disclosure can be changed and carried out within a range not deviating from the gist of the present disclosure.

The processing and means described in the present disclosure can be freely combined and implemented unless technical contradiction occurs.

Further, the processing described as being performed by one apparatus may be shared and executed by a plurality of apparatuses. For example, the advertisement delivery server may be an in-vehicle terminal which is mounted on a vehicle on which users share a ride. Further, functions of the advertisement delivery server may be shared between a computer apparatus and the in-vehicle terminal and executed. Further, the advertisement delivery server may perform the facility extraction processing or the related facility extraction processing and transmit target facility information or target related facility information to the user terminal, and the user terminal may perform the advertisement delivery processing. Alternatively, the processing described as being performed by different apparatuses may be executed by one apparatus. In a computer system, a hardware configuration (server configuration) which executes each function can be flexibly changed.

The present disclosure can be implemented by a computer program which implements the functions described in the above-described embodiments being supplied to a computer, and one or more processors of the computer reading out and executing the program. Such a computer program may be provided to the computer by a non-transitory computer-readable storage medium which can be connected to a system bus of the computer or may be provided to the computer via a network. The non-transitory computer-readable storage medium includes, for example, an arbitrary type of disk such as a magnetic disk (such as a floppy (registered trade mark) disk and a hard disk drive (HDD)), and an optical disk (such as a CD-ROM, a DVD disk and a blue-ray disk), a read only memory (ROM), a random access memory (RAM), an EPROM, an EEPROM, a magnetic card, a flash memory, an optical card, and an arbitrary type of medium appropriate for storing electronic commands.

What is claimed is:

1. An information processing apparatus comprising a controller which executes:
acquiring information relating to a destination of a user of a vehicle;
extracting advertisement information of a facility which is located within a first range including the destination and for which advertisement information is to be provided to the user;
acquiring a current location of a terminal of the user;
judging whether or not the current location of the terminal of the user is located within a second range including the destination; and
transmitting the advertisement information to the terminal of the user in a case where the current location of the terminal of the user is located within the second range.

2. The information processing apparatus according to claim 1,
wherein the controller further executes:
acquiring a moving route of the vehicle to the destination;
extracting a related facility which is located within a third range including the moving route and which relates to the facility; and
transmitting the advertisement information to the terminal of the user in a case where the current location of the terminal of the user is located within a fourth range including the related facility.

3. The information processing apparatus according to claim 1,
wherein the controller accepts a request indicating that the user does not desire provision of the advertisement information from the user.

4. The information processing apparatus according to claim 1,
wherein a request for providing the advertisement information which is to be provided to the user, also to other users is accepted from one of a plurality of users of the vehicle.

5. The information processing apparatus according to claim 1,
wherein the controller provides a privilege to the user who receives provision of the advertisement information in accordance with provision history of the advertisement information.

6. An information processing method comprising:
a step of acquiring information relating to a destination of a user of a vehicle;
a step of extracting advertisement information of a facility which is located within a first range including the destination and for which advertisement information is to be provided to the user;
a step of acquiring a current location of a terminal of the user;
a step of judging whether or not the current location of the terminal of the user is located within a second range including the destination; and
a step of transmitting the advertisement information to the terminal of the user in a case where the current location of the terminal of the user is located within the second range.

7. A non-transitory computer readable storing medium recording a computer program for causing a computer to perform an information processing method comprising:
a step of acquiring information relating to a destination of a user of a vehicle;
a step of extracting advertisement information of a facility which is located within a first range including the destination and for which advertisement information is to be provided to the user;
a step of acquiring a current location of a terminal of the user;
a step of judging whether or not the current location of the terminal of the user is located within a second range including the destination; and
a step of transmitting the advertisement information to the terminal of the user in a case where the current location of the terminal of the user is located within the second range.
